(19) United States
(12) Patent Application Publication
(10) Pub. No.: US 2023/0046648 A1
(43) Pub. Date: Feb. 16, 2023

(54) WALL AND CEILING MOUNTED STORAGE SYSTEMS

(71) Applicants: WILLIAM D. LESLIE, BRADENTON, FL (US); BRADLEY J. KAPPER, BRADENTON, FL (US)

(72) Inventors: WILLIAM D. LESLIE, BRADENTON, FL (US); BRADLEY J. KAPPER, BRADENTON, FL (US)

(73) Assignee: EQUIPMOUNT LLC, BRADENTON, FL (US)

(21) Appl. No.: 17/974,567

(22) Filed: Oct. 27, 2022

Related U.S. Application Data
(63) Continuation-in-part of application No. 16/856,769, filed on Apr. 23, 2020.

(51) Int. Cl. A47B 96/06; A47B 96/02; B62H 3/12

(52) U.S. Cl. CPC A47B 96/06; A47B 96/02; B62H 3/12

(57) ABSTRACT

Surface attachable storage systems having a base rail (7) for attachment to a wall (1) or ceiling (2) surface, an outer rail (11) for attachment to the base rail to form a rail assembly (3), the outer rail having means for attaching accessories for holding storage items and at least one accessory (4, 5) for holding storage items. The means on the outer rail for attaching accessories for holding storage items may be at least one pin-receiving socket (17) in the outer rail of the rail assembly for inserting a mating bayonet-type pin (23) on an accessory or a T-slot (15) in the outer rail of the rail assembly for inserting T-pins (26, 30) of an accessory.

### CROSS-REFERENCE TO RELATED APPLICATION

This application is a continuation-in-part of application Ser. No. 16/856,769 filed on Apr. 23, 2020, which is currently pending. The patent application identified above are incorporated herein by reference in their entirety to provide continuity of disclosure.

### FIELD OF THE INVENTION

This invention relates to wall and ceiling mounted storage systems, and more particularly a system for quickly attaching system components for customizing storage racks in garages and other locations.

### BACKGROUND OF THE INVENTION

Storage of recreational items, such as bicycles, kayaks, camping and other items to the walls and ceilings of garages and other locations is desired by just about everyone. A major problem with most storage systems intended to satisfy that desire is that such storage systems require significant time for installation and often result in the marring and alteration of wall and ceiling surfaces. Additionally, such storage systems are not flexible and adaptable in use to hold and store a variety of recreational equipment.

Therefore, a need exists for a wall and ceiling surface mounted storage system that is easy and quick to install, is flexible in terms of use and types of recreational and other equipment, such as without limitation, bicycles, kayaks and camping gear, it can store and to which such equipment can be quickly attached and removed a necessary.

### SUMMARY OF THE INVENTION

The primary object of the present invention is to provide a wall and ceiling surface mountable storage system that can be easily and quickly installed.

Another object of the present invention is to provide such a storage system that is flexible in use as to the type of equipment it can store.

An additional object of the present invention is to provide such a storage system that is easy and quick to use for attaching and removing items as needed.

The present invention fulfills the above and other objects by providing a surface attachable storage system having a base rail for attachment to a wall or ceiling surface, an outer rail for attachment to the base rail to form a rail assembly, said outer rail having means for attaching accessories for holding storage items. The outer rail has top and bottom flanges to fit over the top and bottom flanges of the base rail to form the rail assembly. The means for attaching accessories to the rail assembly for holding storage items may be pin-holding sockets in the outer rail of the rail assembly for inserting a mating bayonet-type pin on an accessory and/or a T-socket in the outer rail of the rail assembly for inserting T-pins of an accessory.

The accessory storage holders may be designed to hold a desired item to be stored, such as a bicycle hanger, a hanging shelf, a .l-hook, a double hook, a T-bar or other accessory. The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of the wall and ceiling surface attachment rails of the storage system of the present invention without items;

FIG. 2 is a perspective view of the wall and ceiling surface attachment rails of the storage system of the present invention with some components and recreational items store thereon;

FIG. 3A is a front view of the base surface attachment rail of the storage system of the present invention;

FIG. 3B is an end view of the base surface attachment rail of the storage system of the present invention;

FIG. 4A is a perspective view of the outer attachment rail of the storage system of the present invention;

FIG. 4B is an end of the outer attachment rail of the storage system of the present invention;

FIG. 5 is a perspective exploded view of the base and outer attachment rails with components prior to formation of the rail assembly of the storage system of the present invention;

FIG. 6 is a perspective view of the rail assembly of the storage system of the present invention;

FIG. 7A is a side view of a bike hanger component of the storage system of the present invention;

FIG. 7B is a perspective view of a bike hanger component of the storage system of the present invention;

FIG. 7C is a top view of a bike hanger component of the storage system of the present invention;

FIG. 7D is a side view of a bike hanger component of the storage system of the present invention;

FIG. 8 is a perspective view of a hanging shelf component of the storage system of the present invention;

FIG. 9 is a perspective view of a T-pin attachment of the storage system of the present invention;

FIG. 10A is a perspective view of a J-hook attachment of the storage system of the present invention;

FIG. 10B is a side view of a J-hook attachment of the storage system of the present invention;

FIG. 11A is a side view of a double hook attachment component of the storage system of the present invention;

FIG. 11B is a perspective view of a double hook attachment component of the storage system of the present invention;

FIG. 11C is an end view of a double hook attachment component of the storage system of the present invention;

FIG. 12 is a perspective view of an overhead storage shelf component of the storage system of the present invention;

FIG. 13A is a front view of a T-bar overhead storage component of the storage system of the present invention;

FIG. 13B is a perspective exploded view of a T-bar overhead storage component of the storage system of the present invention;

FIG. 14 is a perspective plan view of a quick disconnect pin receiver of the storage system of the present invention; and

FIG. 15 is an exploded side perspective view of a bayonet-type pin of the storage system of the present invention.

### DESCRIPTION OF THE PREFERRED EMBODIMENTS

For purposes of describing the preferred embodiment, the terminology used in reference to the numbered accessories in the drawings is as follows:

1. wall

2. ceiling

3. rail assembly

4. storage hook attachment accessories

5. storage T-attachment accessories

6. kayak

7. base surface rail

8. pre-drilled attachment slots

9a. top flange of 7

9b. bottom flange of 7

10. inner flanges of 7

11. outer rail

12. front surface of outer rail

13. socket holes

14. screw holes

15. T-slots

16. rail holding flanges

17. pin receiving sockets

18. socket holding washers

19. bicycle wheel cradle

20. bicycle hook

21. rubber coating

22. hook sleeve holder

23. bayonet-type pin

24. folding hanging shelf

25. screws

26. T-pin

27. T-pin component attachment

28. J-hook

29. rubber coating

30. flat T-pin

31. overhead storage shelf

32. legs

33. cross pieces

34. bolts

35. overhead storage T-bar

36. arms

37. holding collars

38. upright

39. arm holding inserts

40. top edge of receiver

41. receiver slot

42. flange

43. pin

44. outer surface of receiver

45. bottom edge of receiver

46. inner surface of receiver

47. opening in pin channel

48. channel

49. locking opening in pin channel

50. bottom of bayonet pin

51. top of bayonet pin

52. double hook accessory component

53. elongated flat T-pin

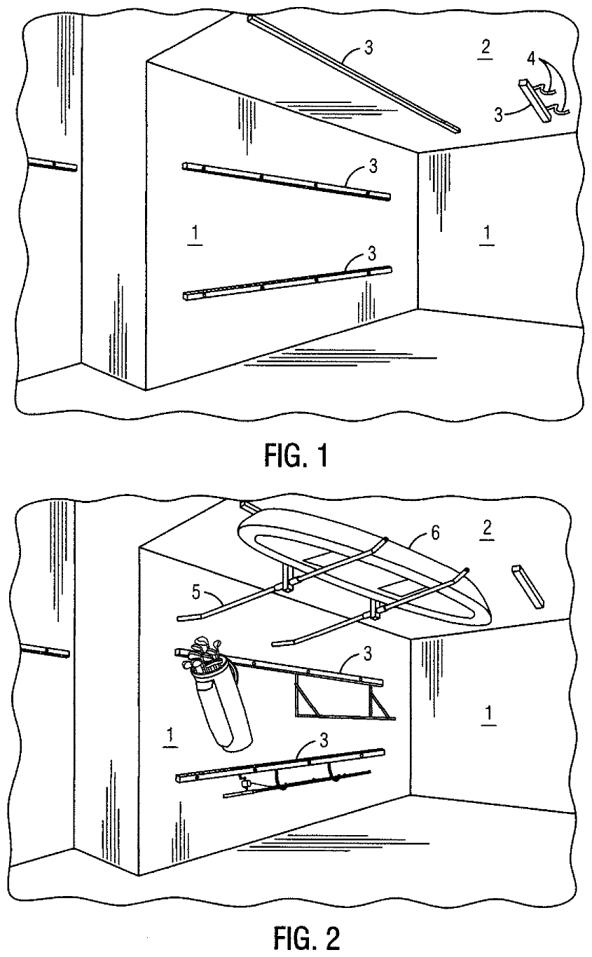

With reference to FIGS. 1 and 2, perspective side views of the storage system without stored items and with stored items, respectively, as installed on a wall 1 and ceiling 2 of a garage or other location, are illustrated. The storage system of the present invention comprises a rail assembly 3, the components of which are described in more detail hereinafter, which are attached to a surface, such as a wall 1 or ceiling 2. Then attachment components, such as hooks 4, T-attachments and other attachments, can be easily and quickly attached to the rail assembly 3, to enable storage items, such as kayaks 6 and other items to be secured.

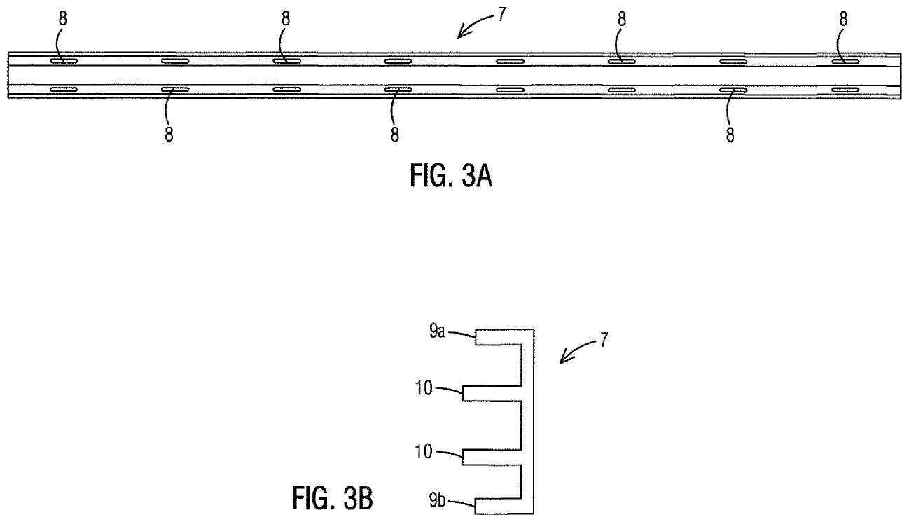

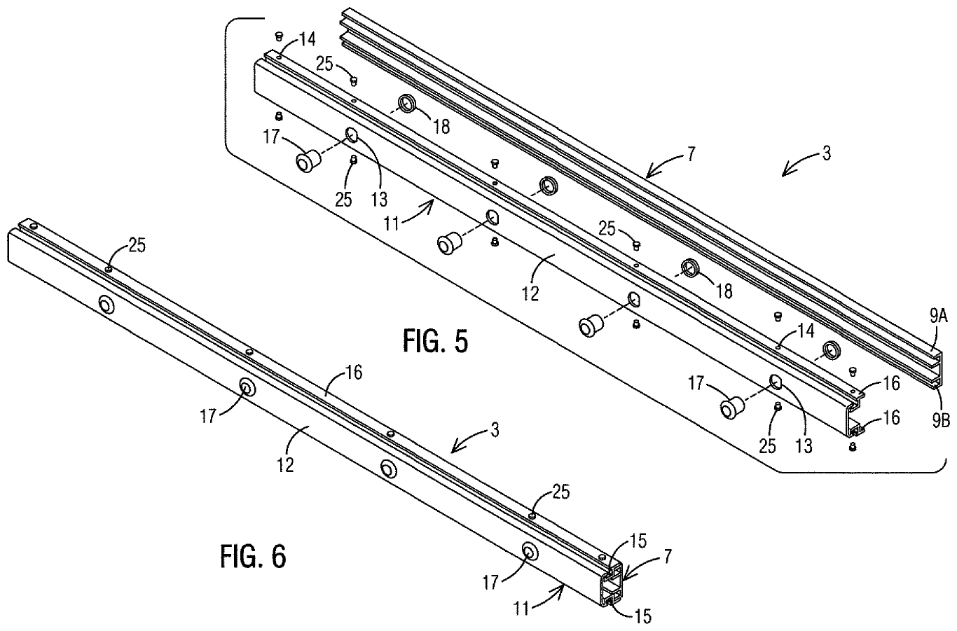

FIGS. 3A and 3B illustrate in front and end views, respectively, the base surface rail 7 of the rail assembly 3 of the storage system of the present invention. The elongated base rail 7 preferably has a plurality of pre-drilled slots 8 along its length for attaching the base rail 7 to studs in a wall or ceiling or to a block wall. The base rail 7 has a top flange 9a and a bottom flange 9b for attaching an outer rail 11 as described in FIG. 6, to form the rail assembly 3. Inner flanges or ridges 10 running along the length of the inner rail bottom may be provided primarily to provide strength to the inner rail 7.

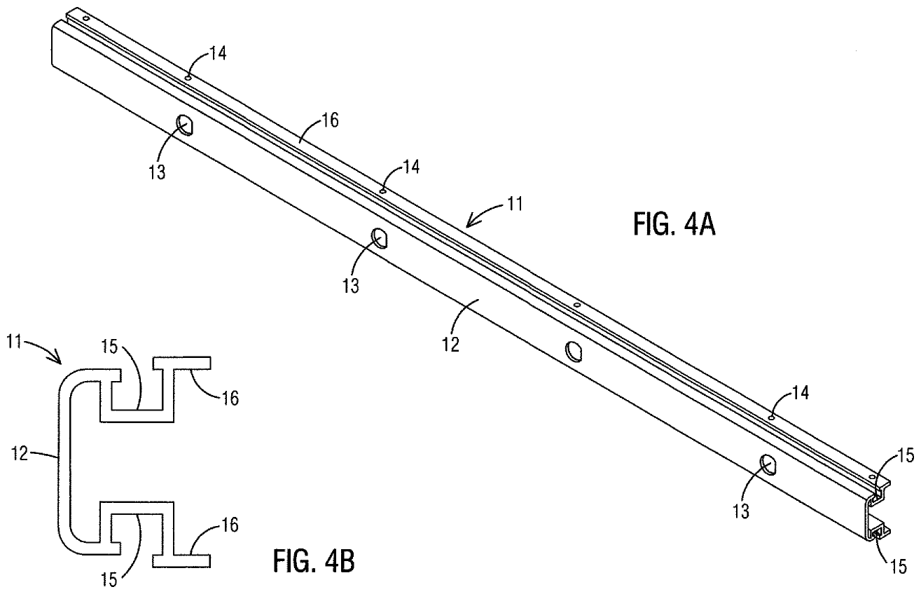

FIGS. 4A and 4B illustrate in perspective and end views, respectively, the outer rail 11 of the rail assembly 3 of the storage system present invention. The outer rail 11 has top and bottom rail holding flanges 16 which fit over the inner base rail 7. The flanges 16 contain a plurality of screw holes 14 into which screws are inserted and tightened to secure it to the base rail 7. An outer surface 12 of the outer rail 11 has a plurality of holes 13 into which pin-holding sockets (not shown, but described hereinafter) are inserted to hold storage item holding attachments. The outer rail also preferably has T-slots channels 15 for inserting T-pin storage attachments, as described hereinafter.

FIGS. 5 and 6 illustrate in perspective views an exploded view of the components of the rail assembly and the completed rail assembly, respectively, of the storage system of the present invention. FIG. 5 shows the base rail 7 which would already be attached to a wall or ceiling surface. After the outer rail 11 contains a plurality of apertures 13 on its front surface 12 into which pin receiving sockets 17 (described in detail hereinafter) are inserted and secured from an inside by washers 18. Then the outer rail 11 is placed over the base rail 7 with flanges 16 place over the top and bottom flanges 9a and 9b of the base rail and secured by screws 25. FIG. 6 shows the rail assembly 3 which is now ready to attach storage item attachment components in the pin-receiving sockets 17 on the front 12 or in T-slots 15 on the outer sides of the rail assembly 3.

It is now deemed necessary to refer to FIG. 14 to present the details of the pin-receiving sockets 17 that are located in the rail assembly 3 as discussed above. Each socket 17 has an outer flange 42, an outer circumferential surface 44, a top edge 40 and bottom edge 45 with a pin receiving slot 41. A pin is located within the receiver 17 which extends from the wall surface 46 into the receiver slot 41 to engage in a slot in the bayonet type pin 23 as discussed hereinafter.

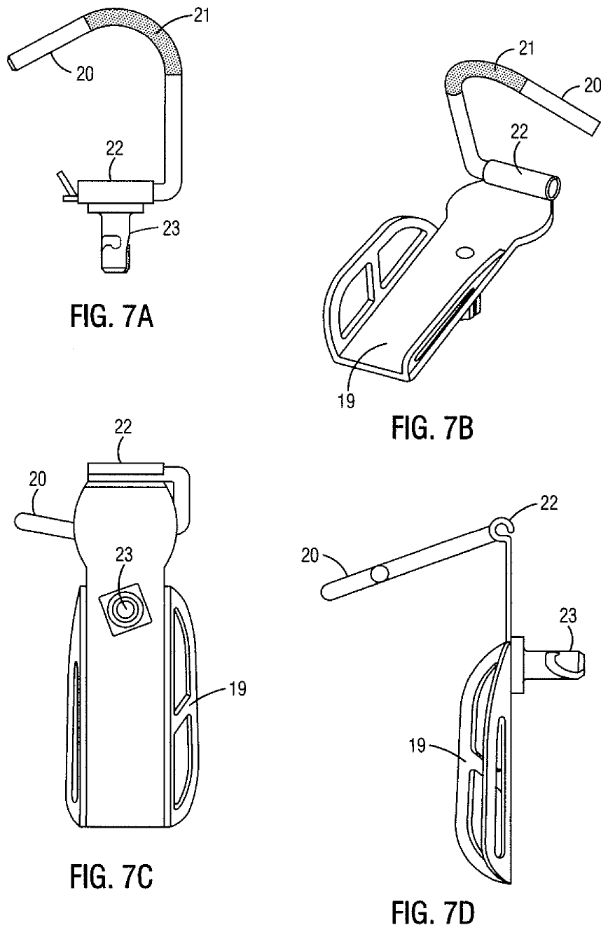

Referring now to FIGS. 7A,7B and 7C, a side, perspective and top views, respectively, of a bicycle hanger component are illustrated. The bicycle hanger component has a hook 20, which may have a rubber coating 21 to prevent scraping damage to a bike, said hook 20 being attached to a sleeve 22 secured to a bayonet type pin 23 for insertion into a socket 17 as discussed previously. The bike attachment component also has a cradle 19 for holding the wheel of a bike being mounted.

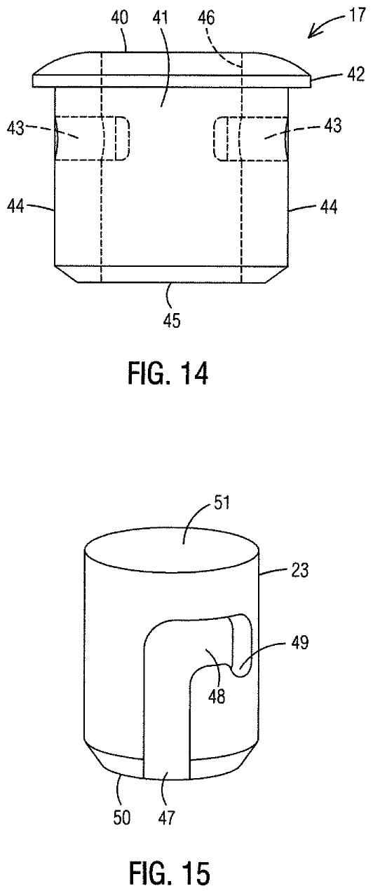

To understand the bayonet-type pin attachment 23 used in this invention reference is made to FIG. 15. This pin 23 has an opening pin channel 47 in a bottom which extends from a bottom of the pin 50 upward toward the top of the pin 51 to a horizontal channel 48 having a locking opening 49 at the end. In operation the bayonet pin 23 when inserted into the slot 41 of the receiver 17 engages the pins 43 in the channel and when pushed further inward in the socket slot 41 and twisted passes through the channel 48 to lock the pin 23 in the receiver 17.

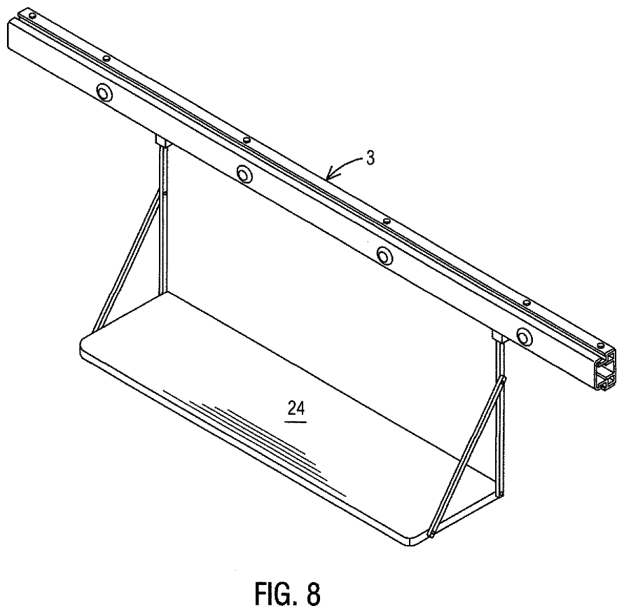

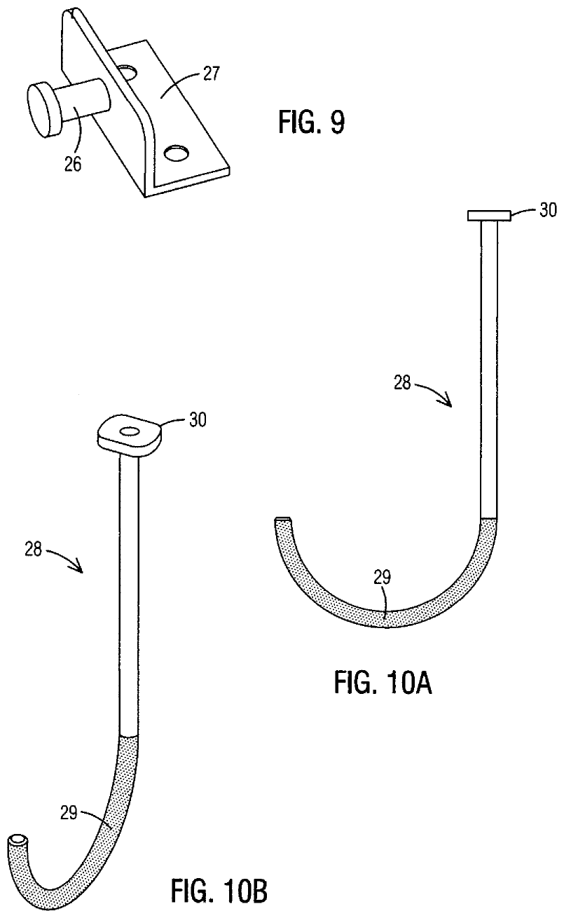

FIG. 8 illustrates a folding hanging shelf 24 attached to the rail assembly 3 by a T-pin 26 inserted in a T-slot 15 as discussed previously. FIG. 9 illustrates the T-pin 26 with

T-pin attachment component to which a hanging shelf or other component may be attached for use with the system of the present invention.

FIGS. 10A and 10B illustrate a side and perspective view of a J-hook 28 having a flat T-pin 30 on top for insertion into one of the T-slots 15 of the rail assembly 3. This J-hook 28 may be used to hang bikes and other items and has rubber coating 29 on a lower hook portion to help prevent damage to the item being hung.

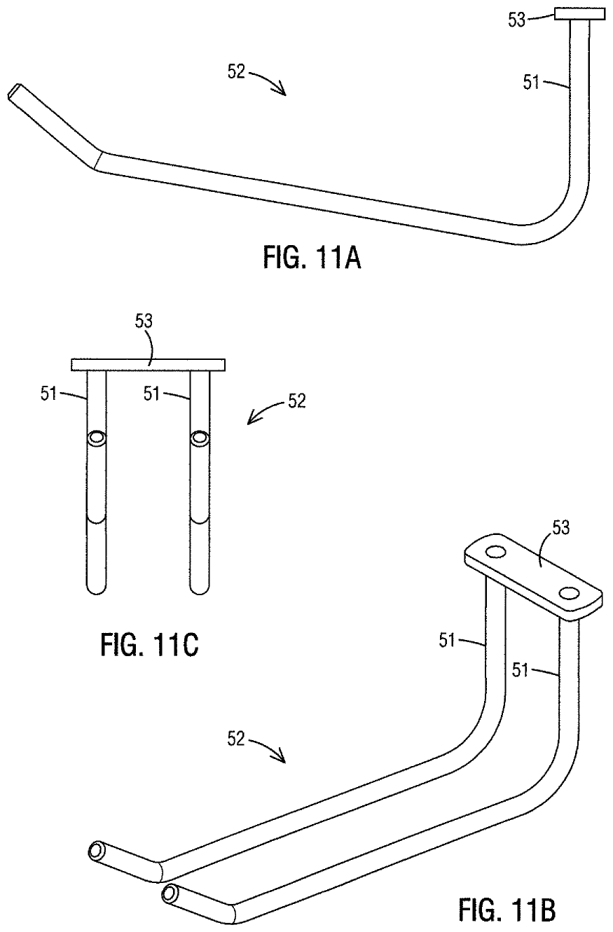

FIGS. 11A, 11B and 11C illustrate side, perspective and front views, respectively, of a double hook attachment component having two legs 51 extending from an elongated T-pin 52 that may be inserted into a T-slot 15 in the rail assembly 3 to hang storage items.

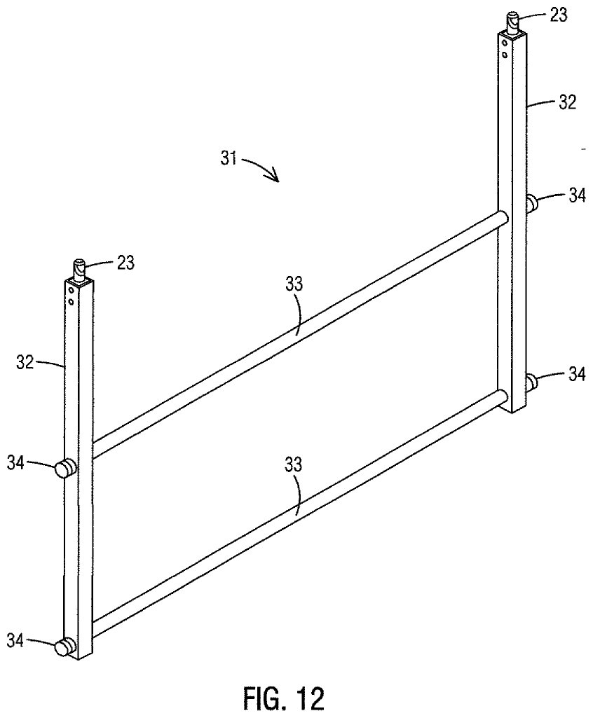

FIG. 12 illustrates an overhead storage component 31 having vertical legs 32 with horizontal crosspieces 33 between them connected by bolts 32. This component uses the bayonet type pin 23 to attach it to the rail assembly 3 by insertion of the pin 23 into the socket 17.

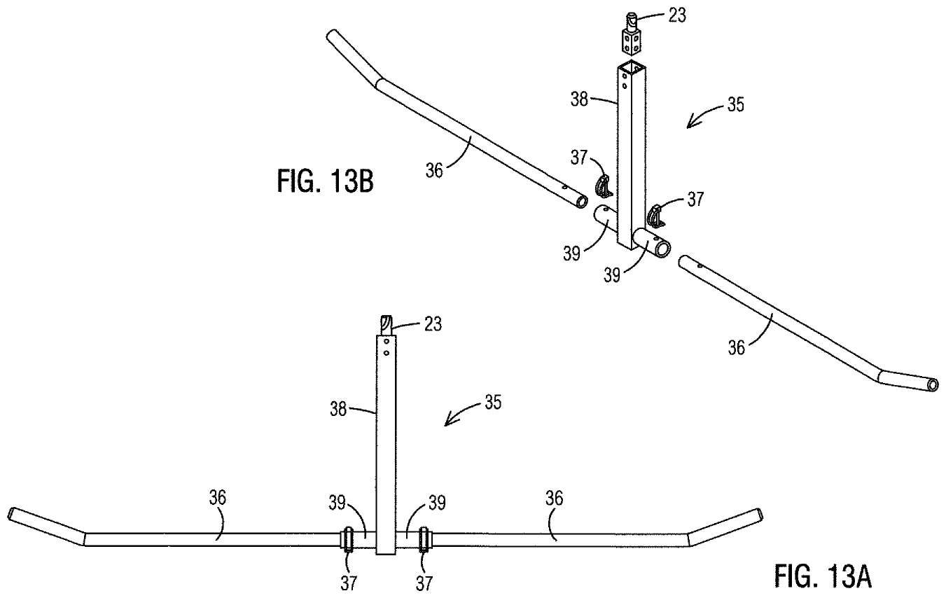

The remaining drawings that have not been previously discussed are FIGS. 13A and 13B which illustrate front and perspective views, respectively, of an overhead storage T-bar 35, probably most useful in hanging kayaks from a ceiling. This storage component has at least two legs 36 inserted into holding extensions with collars 37 extending outward from an upright 38. The upright has a bayonet type T-pin 23 which enables the storage T-bar to be attached to the rail assembly 3 by inserting the pin 23 into a receiving socket 17.

As described above, the present invention provides a flexible storage system that is quick and simple to install and use. The method of installation involves first, attaching the pre=drilled base rail 7 to a stud or block to a wall 1 or ceiling 2. Second, the outer rail or face plate 11 is attached over and to the base rail 7. Then the attachment accessory components, which may vary depending on the type of storage items, can be attached to the rail assembly 25 by plugging directly into the receivers or in T-slots above and below the rail assembly 3.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described our invention, we claim:

1. A surface attachable storage system comprising:
a base rail for attachment to a wall or ceiling surface;
an outer rail for attachment to the base rail to form a rail assembly, said outer rail having means for attaching accessories for holding storage items;
at least one accessory for holding storage items.

2. The surface attachable storage system of claim 1 wherein:
the base rail has top and bottom flanges and the outer rail also has top and bottom flanges to fit over the top and bottom flanges of the base rail to form the rail assembly.

3. The surface attachable storage system of claim 1 wherein the means for attaching accessories for holding storage items comprises:
at least one pin-holding socket in the outer rail of the rail assembly for inserting a mating bayonet-type pin on an accessory.

4. The surface attachable storage system of claim 1 wherein the means for attaching accessories for holding storage items comprises:
a T-socket in the outer rail of the rail assembly for inserting T-pins of an accessory.

5. The surface attachable storage system of claim 1 wherein:
the at least one accessory is a bicycle hanger.

6. The surface attachable storage system of claim 1 wherein:
the at least one accessory is a hanging shelf.

7. The surface attachable storage system of claim 1 wherein:
the at least one accessory is a J-hook.

8. The surface attachable storage system of claim 1 wherein:
the at least one accessory is a double hook.

9. The surface attachable storage system of claim 1 wherein:
the at least one accessory is a T-bar.

10. A surface attachable storage system comprising:
a base rail for attachment to a wall or ceiling surface;
an outer rail for attachment to the base rail to form a rail assembly, said outer rail having means for attaching accessories for holding storage items;
at least one accessory for holding storage items wherein the base rail has top and bottom flanges and the outer rail also has top and bottom flanges to fit over the top and bottom flanges of the base rail to form the rail assembly and wherein the means for attaching accessories for holding storage items comprises at least one pin-holding socket in the outer rail of the rail assembly for inserting a mating bayonet-type pin on an accessory and at least one T-socket in the outer rail of the rail assembly for inserting T-pins of an accessory.

11. A method of using a surface attachable storage system comprising
a base rail for attachment to a wall or ceiling surface; an outer rail for attachment to the base rail to form a rail assembly, said outer rail having means for attaching accessories for holding storage items; and at least one accessory for holding storage items said method comprising the steps of:
a. attaching the base rail to a surface;
b. attaching the outer rail over and to the base rail to form the rail assembly; and
c. attaching accessories for holding storage items to the rail assembly.

12. The method of claim 11 wherein the means of attaching accessories for holding storage items comprises mating bayonet type pins on the accessories and pin-receiving sockets in the rail assembly.

13. The method of claim 11 wherein the means of attaching accessories for holding storage items comprises mating T-pins on the accessories and T-pin receiving slots in the rail assembly.
